(19) United States
(12) Patent Application Publication
(10) Pub. No.: US 2021/0015118 A1
(43) Pub. Date: Jan. 21, 2021

(54) ADULT SURPRISE GIFT APPARATUS

(71) Applicant: Melinda Joy Oosterhof, St. Catharines (CA)

(72) Inventor: Melinda Joy Oosterhof, St. Catharines (CA)

(21) Appl. No.: 16/947,040

(22) Filed: Jul. 15, 2020

Related U.S. Application Data
(60) Provisional application No. 62/874,299, filed on Jul. 15, 2019.

(51) Int. Cl. A23G 1/54; B65D 85/60

(52) U.S. Cl. CPC A23G 1/545; B65D 11/02; B65D 85/60

(57) ABSTRACT

An adult novelty gift apparatus having an interior non-edible container having two or more sections forming a hollow interior and an optional edible coating, such as chocolate or candy, surrounding the non-edible container. An adult themed novelty gift will be located within the interior of the nonedible container. A decorative exterior covering, containing branding, may be applied to the outer surface of the non-edible container. The non-edible container may have an outer surface that is an ovoid shape.

### CROSS-REFERENCE TO RELATED APPLICATIONS

This application claims the benefit of pending U.S. provisional patent application No. 62/874,299 filed Jul. 15, 2019, and is incorporated herein in its entirety.

### FIELD OF THE INVENTION

The present disclosure relates to an apparatus comprising a container or packaging for a gift or novelty item, particularly to an adult gift or novelty item, more particularly to an apparatus containing a surprise adult themed gift or novelty item.

### BACKGROUND

Small novelty items, miniature toys and edible snack items are commonly sold in containers formed in a non-edible material such as plastic. Containers of this type are typically egg shaped around and comprise two half sections with forming a hollow interior within which the toy is contained. The nonedible container may be encased in an edible material such as chocolate, then wrapped in various packaging materials such as cellophane or a metal foil. In the prior art, the toys and various novelties contained within the nonedible container are typically directed toward children. These toys may be little toy cars, plastic rings, etc.

Numerous patent documents are available that describe egg shaped plastic containers that contain children's toys, some of which also include an edible layer. For example: WO1993000267; U.S. Pat. No. 5,925,391; WO2017176222; CA2408713; CA2570412; U.S. Pat. Nos. 7,959,025; 7,959,025; WO2012084795; WO1995028327; DE2324344; and U.S. Pat. No. 8,859,024.

None of the above cited documents, alone or in combination satisfy the need for an adult surprise gift apparatus, hence there remains a need for an apparatus for the giving of a novelty gift, where the item is specifically directed toward adults.

### BRIEF SUMMARY

It is an object of the invention to provide an adult surprise gift apparatus.

In accordance with an aspect of the invention there is provided an adult surprise gift apparatus comprising: a hollow container having an approximate ovoid outer surface; an adult gift or novelty contained within said container; and an outer packaging layer formed around the outer surface of said container.

In accordance with an aspect of the invention there is provided an adult surprise gift apparatus, comprising: a hollow chocolate shell having an approximate ovoid outer surface; an adult gift or novelty contained within said hollow chocolate shell; and an outer packaging layer formed around the outer surface of said hollow chocolate shell.

In accordance with another aspect of the invention there is provided a kit for the preparation of an adult surprise gift apparatus, comprising: a hollow container having an approximate ovoid outer surface, said container being made from biodegradable or compostable plastic, or a plant based material; and an outer packaging layer formed around the outer surface of said container, said outer packaging layer is selected from the group consisting of cellophane, aluminum, plant-based film, metal foil and ribbon, said packaging further containing branding markings.

The advantages and features of the present invention will become better understood with reference to the following more detailed description and claims taken in conjunction with the accompanying drawings in which like elements are identified with like symbols.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

The figures which accompany the written portion of this specification illustrate embodiments of the present invention, constructed and operative according to the teachings of the present invention.

The various embodiments of the present invention will hereinafter be described in conjunction with the appended drawings, wherein like designations denote like elements.

FIG. 1 illustrates a side view of an item 100 in accordance with one embodiment of the invention.

FIG. 2 illustrates a cross sectional view of an item 200 in accordance with one embodiment of the invention.

FIG. 3 illustrates an exploded cross-sectional view of an item 300 in accordance with one embodiment of the invention.

FIG. 4 illustrates an exploded perspective view of an item 400 in accordance with one embodiment of the invention.

FIG. 5 illustrates an exploded perspective view of an item 500 in accordance with one embodiment of the invention.

FIG. 6 illustrates an exploded perspective view of an item 600 in accordance with one embodiment of the invention.

FIG. 7 illustrates an exploded perspective view of an item 700 in accordance with one embodiment of the invention.

FIG. 8 illustrates an exploded perspective view of an item 800 in accordance with one embodiment of the invention.

FIG. 9 illustrates a perspective view of an item 900 in accordance with one embodiment of the invention.

FIG. 10 illustrates a perspective view of an item 1000 in accordance with one embodiment of the invention.

### DETAILED DESCRIPTION

Devices and methods for carrying out the invention are presented in terms of embodiments depicted within the FIGS. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope.

The features of the invention which are believed to be novel are particularly pointed out in the specification. The present invention now will be described more fully hereinafter with reference to the accompanying drawings, which are intended to be read in conjunction with the summary, the detailed description and any preferred, alternative or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

The present invention advantageously fills the aforementioned deficiencies by the known prior art. The present invention is superior to other novelty gift apparatus in that it provides for an adult themed novelty gift apparatus. Embodiments of the present invention relate to an apparatus including an interior non-edible container having two sections forming a hollow interior and an edible coating, such as chocolate or candy, surrounding the non-edible container. The apparatus may be packaged in various and known packaging materials such as cellophane or metal foil. An adult themed novelty gift may be located within the interior of the nonedible container. The adult themed gift may be any gift that can fit within the container, such as vial of massage oil, a flavored condom, or an article of clothing such as a thong. The listing of these adult novelty items is illustrative, and not meant to be limiting. Those skilled in the art will recognize that other adult themed items may be placed within the interior of the nonedible container.

The present invention is directed to an adult themed novelty gift apparatus. The gift may or may not be enclosed within a layer of packaging and this will be determined by the nature of the gift and the material of the next layer of packaging. If the gift is to be enclosed within a layer of packaging, this may be selected from the group of plastic, biodegradable plastic, or protein-polysaccharide film.

Embodiments of the present invention may include additional packaging around the gift that is a non-edible container having two or more sections forming a hollow interior. The first, second, third, and additional sections may be formed of nonedible material such as plastic or other material that may be lightweight, or flexible. The nonedible material may be biodegradable or compostable, or a plant-based material such as cornstarch, mushroom mycelium composite material, protein-polysaccharide polymers, or seaweed. When assembled, the sections define a hollow interior which can receive an adult novelty gift, which may or may not be enclosed with a layer of packaging.

In certain embodiments of the invention, an optional edible coating, such as chocolate or candy, may either surround or be enclosed with the non-edible container. The apparatus may optionally be packaged in various and known packaging materials such as cellophane, a plant-based film or metal foil.

In other embodiments of the invention the adult themed novelty gift, which may or may not be enclosed within a layer of packaging, is enclosed directly within an edible coating, such as chocolate or candy. Typically, when the coating is chocolate, the gift is enclosed within preformed hollow chocolate shells and heat sealed around the gift. A layer of cellophane, plant-based film or metal foil may then be used as the outer covering.

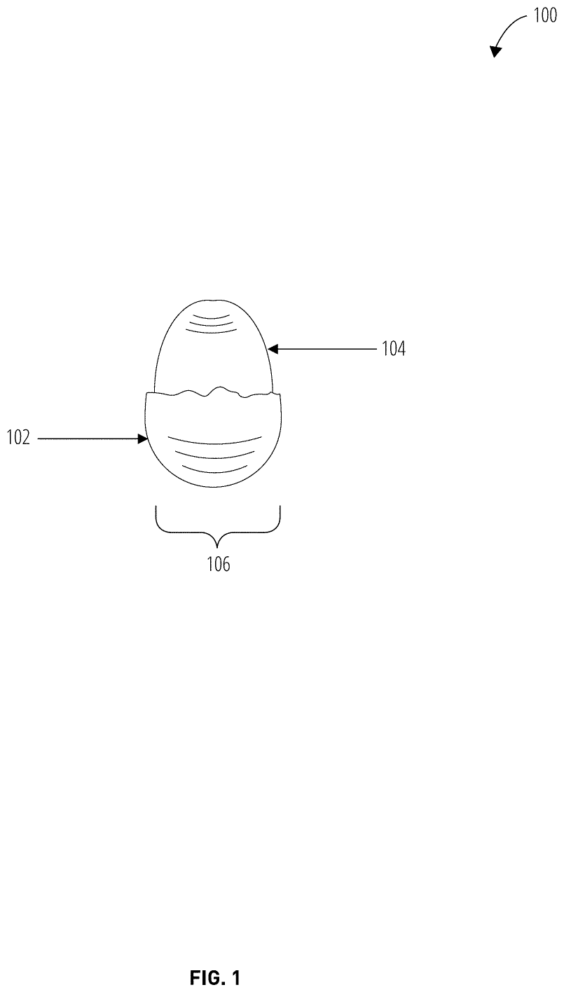

Referring now to the drawings, there is shown in FIGS. 1-10, various embodiments of the adult themed novelty gift apparatus of the present invention.

FIG. 1 shows an embodiment of the invention wherein the internal non edible container 104, which encloses an adult gift (not shown) is indicated in relation to an external edible coating 102. As illustrated in this drawing, a layer of edible material may be located along the outer surface of the internal non edible container 104. The edible material may be chocolate, candy, or other confectionery or confectionery material. The edible material may be applied to the container by any known process, such as layering and or dipping. In the alternative, the external edible coating 102 may be made using known techniques as a pre-molded shell that is then sealed around the internal non edible container 104.

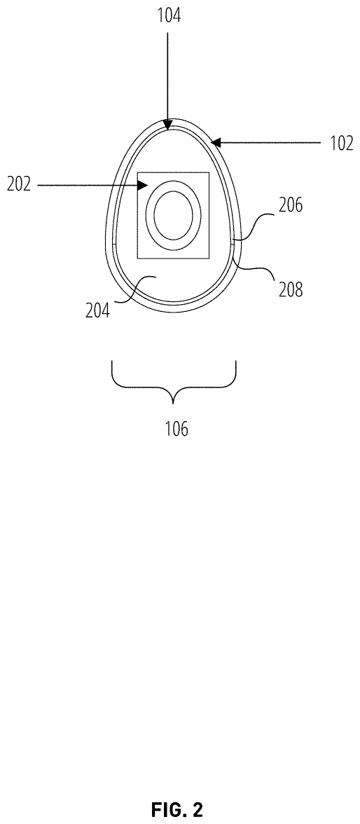

FIG. 2 shows an embodiment of the invention wherein a novelty adult gift 202 is placed within an internal non edible container 104. In this embodiment, the internal non edible container 104 comprises a first section of non-edible container 206 and a second section of non-edible container 208. The first and second sections are then combined and attached to create the container. The sections are sized and proportioned to fit together, either by a series of flanges and/or ridges. The sections may be held in place via friction fit or by a clasp or latch. The pieces may additionally comprise a hinged section (not shown), typically made from a flexible piece of the material that is used to fabricate the container.

The container is then either coated or enclosed within an external edible coating 102. Following the application of the edible material, the apparatus may then be packaged with a durable non-edible packaging material, such as the cellophane, plant-based film or metal foil.

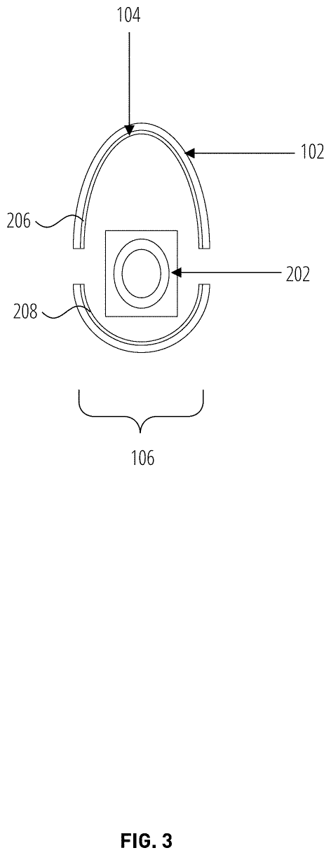

FIG. 3 shows an embodiment of the invention that is illustrated in FIG. 2. This figure shows an exploded view wherein the first section of non-edible container 206 and second section of non-edible container 208 are separate. The external edible coating 102 may be fabricated as two pre-formed molded halves that are joined, typically by heat sealing, in either the horizontal (shown) or vertical (not shown) plane. In the alternative, the internal non edible container 104 may be dipped in the external edible coating 102 prior to being packaged with a durable non-edible packaging material, such as the cellophane, plant-based film or metal foil.

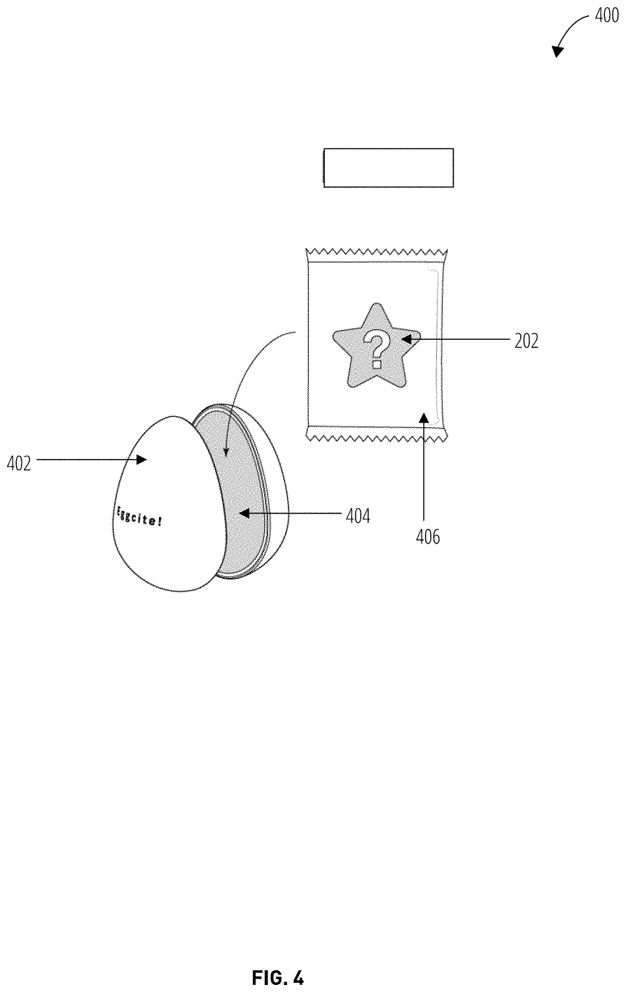

FIG. 4 shows an embodiment of the invention wherein an adult gift 202 is wrapped in a layer of packaging 406. This layer of packaging 406 may be selected from the group of plastic, biodegradable plastic, protein-polysaccharide films or a variety of plant-based materials. In this embodiment, the adult gift 202 is directly enclosed within the interior of non-edible outer layer 404, and does not include an edible coating.

The non-edible outer layer 402 may be composed of plastic, or more preferably biodegradable or compostable bioplastics. Other materials such as protein-polysaccharide polymers may be used to make the non-edible outer layer 402. Plant materials including sugarcane, discarded coconut husks, mushroom roots, cornstarch and paper composites, or composites consisting of blended combinations of wheat straw, bamboo, husks, sugar cane, and/or bulrush can also be used to make the non-edible outer layer 402.

Various embodiments of the invention may be labeled on the outside of the non-edible outer layer 402 with a company branding or logo.

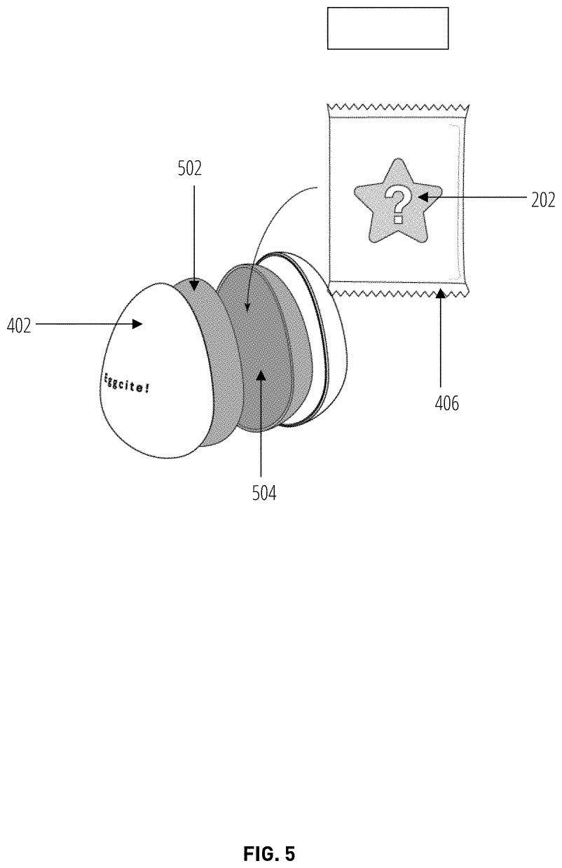

FIG. 5 shows an embodiment of the invention which resembles the embodiment shown in FIG. 4, but differs in that an edible layer 502 is present. For example, in this embodiment the edible layer 502 is present within the interior of non-edible outer layer 404. Again, the adult gift 202 is wrapped in a layer of packaging 406 and inserted into the internal space 504 within the edible layer 502.

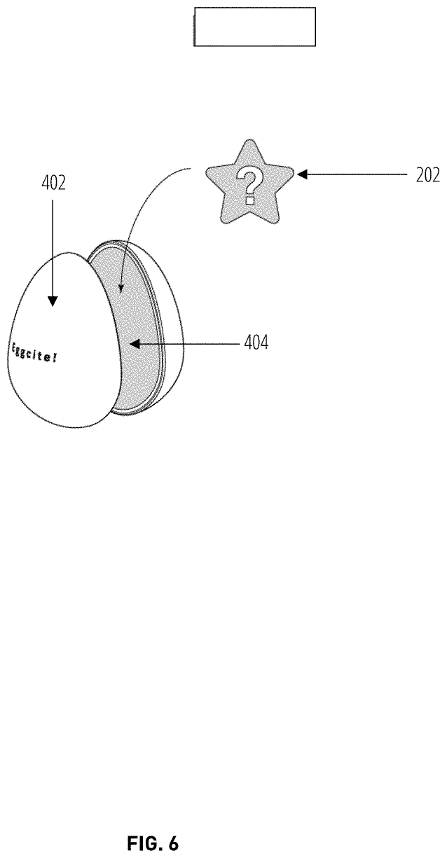

FIG. 6 shows an embodiment of the invention which also resembles the embodiment shown in FIG. 5, but differs in that the adult gift 202 may be directly inserted into the internal space 504 within the edible layer 502 without the layer of packaging 406.

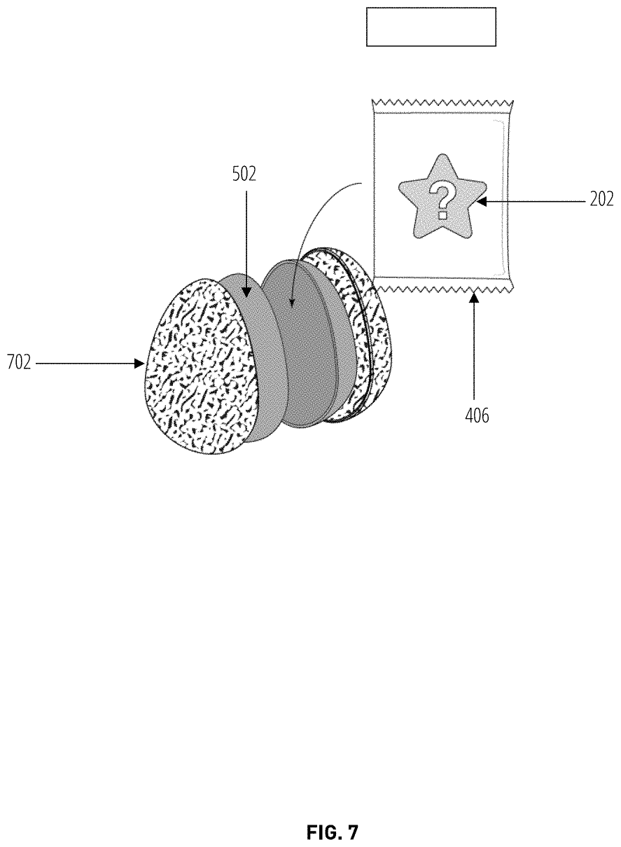

FIG. 7 shows an embodiment of the invention wherein the adult gift 202 is inserted directly into an edible layer 502, The adult gift 202 may optionally be prewrapped in layer of packaging 406, as shown. In this particular embodiment, the edible layer 502 is further wrapped in an external layer of decorative packaging 702. The external layer of decorative packaging 702 may be, but is not limited to, cellophane, a plant-based film or metal foil.

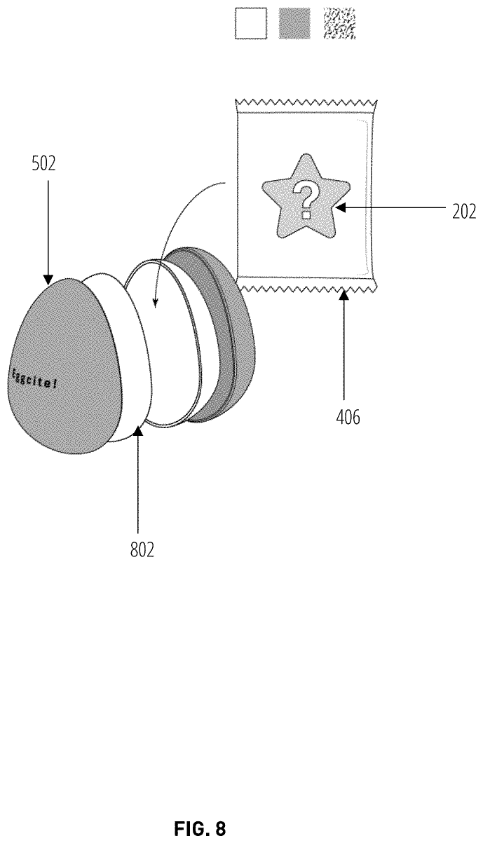

FIG. 8 shows an embodiment of the invention which resembles the embodiment shown in FIG. 7, but differs in that the edible layer 502 is present on the outside of a non-edible inner layer 802. Again, an external layer of decorative packaging 702 may be applied the novelty gift apparatus 106. The external layer of decorative packaging 702 may be, but is not limited to, cellophane, a plant-based film or metal foil.

In the alternative, the adult gift 202 may be prewrapped in a layer of packaging 406 (as shown) or it may be directly inserted into the non-edible inner layer 802 without the layer of packaging 406.

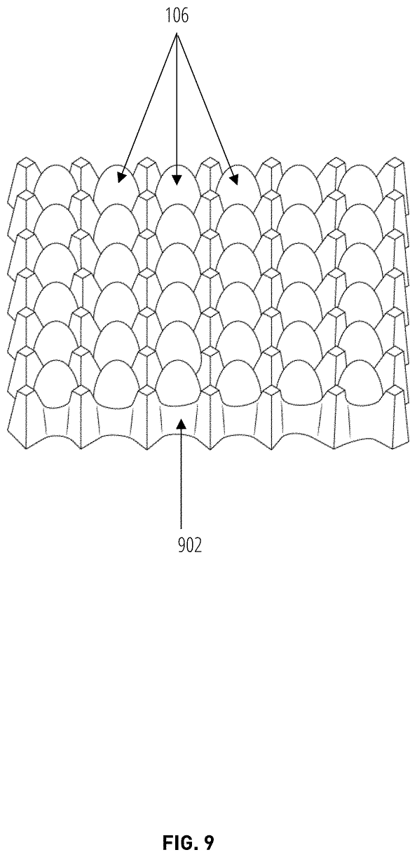

FIG. 9 shows an embodiment of the invention wherein the novelty gift apparatus 106 are sized to fit in a standard egg display tray 902. The eggs may be made in various different sizes to accommodate different the specific adult gift 202, i.e. small, medium, large or extra-large. In the case of novelty gift apparatus 106 that are larger than the standard size of an egg, then it will be necessary to make a larger sized display tray 902.

Recycled cardboard and paper may be used to make the display tray 902, as can various biodegradable plant materials including but not limited to coconut husks.

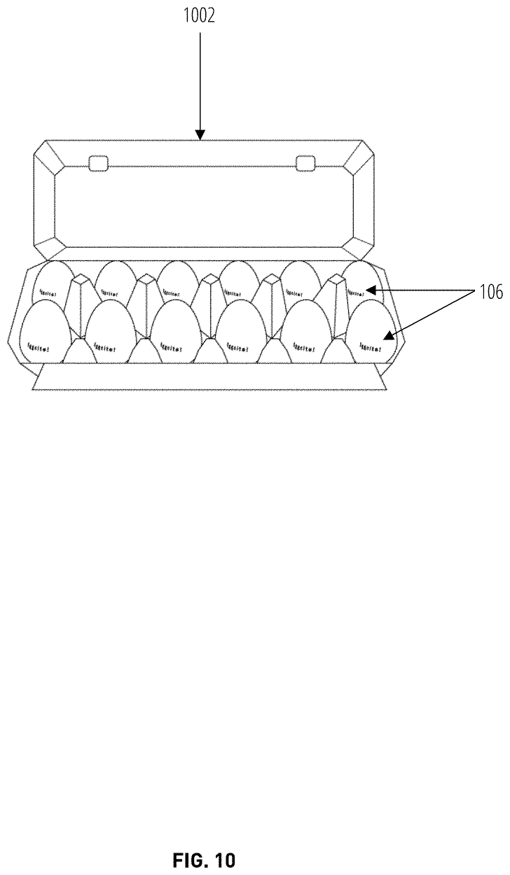

FIG. 10 shows an embodiment of the invention wherein the novelty gift apparatus 106 are sized to fit in a standard egg display box 1002. Again, the eggs may be made in various different sizes to accommodate different the specific adult gift 202. In the case of novelty gift apparatus 106 that are larger than the standard size of an egg, then it will be necessary to make a larger sized display box 1002. Similarly, recycled cardboard and paper may be used to make the display box 1002, as can various biodegradable plant materials including but not limited to coconut husks.

As described above, various alternative embodiments of the invention are contemplated. For example, the adult gift or novelty, can be edible or non-edible, it can be something to be worn, or used. For example: massage oils; lube; condoms (including flavored); cock ring; edible underwear; edible bra; body paints; butt plug; thongs; small vibrator (such as bullet; handcuffs; blindfolds; whip; feather ticklers; sex dice; love coupons; nipple clamps; candles—massage oil; oral sex candy; anal beads; enhancing supplements; nipple suckers; sex position cards—collectable; bed restraints; aphrodisiac warming oil; clit stimulator; ball gag; body pasties; panty teaser; collar; leash; Ben wa balls; and oral sex games. The above non-limiting list of items is described for purposes of clarity and disclosure and not by way of limitation of scope of items that may be included.

The adult gift 202 or novelty, can be enclosed directly within the novelty gift apparatus 106, or it can be wrapped in a layer of packaging 406.

In some embodiments, the novelty gift apparatus 106 may include a non-edible container having two or more sections forming a hollow interior. In other embodiments, the non-edible layer or container is molded around the adult gift 202.

In other embodiments, the novelty gift apparatus 106 may include an edible layer or component. The edible layer may immediately surround the adult gift 202, or it may cover the non-edible container or layer. In certain embodiments, the container is dipped in the edible material, whereas in other embodiments, the edible material is pre-molded into two or more sections that can be sealed together to form the desired outer shape, such as an ovoid or egg shape. The container that encloses the adult gift 202 can then be sealed within the pre-molded sections. When the edible material is chocolate then the sections may be heat sealed.

In alternative embodiments an external layer of decorative packaging 702 may be applied to the novelty gift apparatus 106. The external layer of decorative packaging 702 may contain company branding information or a logo. The apparatus may be packaged in various and known packaging materials such as cellophane or metal foil. The gift apparatus may be sold at any adult fun store and can be used for various purposes such as a party favor, at bachelorette parties, birthdays, or for personal use between a couple.

With regard to the materials used to form the non-edible layer or container that the adult novelty gift is enclosed within, there are numerous different options. Plastics may be considered the most obvious choice, but throughout Canada, the U.S. and around the world there is a growing movement to reduce the amount of single use plastic in products and packaging, particularly plastics derived from fossil fuels. There are now many eco-friendly alternatives to plastic on the market and many are at competitive prices. Many businesses are embracing the opportunities to use eco-friendly options such as switching to either biodegradable and compostable plastics, or at very least using recycled plastic. Compostable bioplastics will completely return to organic matter by becoming nutrient rich biomass through the composting process in as little as 3 months, leaving no toxins or residue like petroleum-based plastics.

In the alternative, composite materials can be formed from plant-based materials. There are numerous plant based materials currently being used in the food packaging industry including, but not limited to: protein-polysaccharide polymers; sugarcane, which can be used as the raw material for polyethylene; discarded coconut husks, which can easily be molded with an organic adhesive to become custom cartons; mushroom roots contain mycelia, which when mixed with natural ingredients like oats will bind together to form a moldable solid; cornstarch is ideal for products with a limited, short-term or single use; and paper composites, which use a blended combination of wheat straw, bamboo, husks, sugar cane, and/or bulrush. All of the above plant-based materials are rapidly biodegradable and/or bio-compostable.

Additional materials for the non-edible layer or container may be formed from protein-polysaccharide powders (whey protein concentrate, alginate, pectin, carrageenan, or konjac flour). These materials typically have low water vapor permeability, higher tensile strength, elastic modulus and elongation, and are optionally edible. In comparative studies, edible/biodegradable materials and traditional synthetic materials (polyethylene terephthalate and polystyrene, the puncture strength of edible/biodegradable materials was nearly seven times greater than synthetic material. Although edible/biodegradable materials have an overall lower mechanical strength than synthetic materials, they are still capable of holding most food products. One great advantage that edible/biodegradable materials is that they generally have significant resistance to oxygen permeability. Conversely, water vapor permeability of edible/biodegradable materials is in general, higher than that of synthetic materials. This is an active area of research, and until modifications have been made to the compositions of edible/biodegradable materials, it may be necessary to wrap the container in a cellophane, aluminum, vapor impermeable plant base films or metal sheet.

An alternative biodegradable material that can be used in the manufacture of the adult novelty non-edible layers or containers is cornstarch. Cornstarch is an organic material that is widely used in the eco-friendly packaging industry. Derived from the corn or maize plant, it has plastic-like properties, which can be used in many contexts that have traditionally relied upon plastics. From bottles to molded forms and loose-fill packaging, cornstarch packaging adds many additional uses to this very North American crop. It is a more environmentally sustainable alternative to petroleum-based packaging.

Yet an alternative biodegradable packaging material can be formed with the aid of mushroom mycelia. It is a relatively inexpensive, eco-friendly packaging alternative that can be used to support or pack smaller items. It uses cleaned and ground agricultural waste, which is then fused together by a matrix of mushroom roots, otherwise known as mycelium. The raw material can be molded into whatever shape is desired, dried, and used as packaging. Not only does this material avoid petroleum and food sources for its raw material, but it also biodegrades at an incredible rate. Mushroom packaging can be composted at home, breaking down into non-toxic, organic matter.

Another form of biodegradable packaging matter can be made from seaweed. The gelatinous substance agar, which is found in a variety of seaweeds and algae, is already used in several packaging applications, especially in the food industry.

Recycled cardboard and paper are widely used to make trays for carrying drinks from fast food stores. The pulped paper and cardstock can easily be molded into the desired shape, such as an egg. Typically, the adult gift 202 would be molded into a ovoid form of unitary construction, or in the alternative, sections of the ovoid shape can be sealed in place to form an ovoid. While cardboard and paper are organic materials, if they are sourced unsustainably, they are readily compostable and their use can have a drastic impact on the environment.

Additionally, there are a number of known eco-friendly and recycled plastics that can be used as a material to make the adult gift container. The containers that are used to enclose the adult themed gift or novelty may come in different sizes, and may be sold at different price points. It is contemplated that whatever outer packaging that is used could be color themed for specific events, such as Valentine's Day, Christmas, birthdays, bachelor or bachelorette parties.

It is also contemplated that the device could be supplied as a kit of parts, to enable the purchaser to custom fill the container to hold a specific gift for a specific event—such as an engagement ring for a marriage proposal, or gifts tailored for specific individuals or events.

The kits may additionally comprise numerous adult themed gifts or novelties, along with numerous different packaging options such as containers to hold the specific gifts or novelties and external packaging variations. Such kits would be intended to be custom packed by the purchaser to enable specific gifts to be matched to specific individuals and personalized by the giver, and would include instructions for assembly.

It is contemplated that the outer packaging would contain the recognizable logo or company branding.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present invention.

What is claimed is:

1. An adult surprise gift apparatus comprising:
a hollow container having an approximate ovoid outer surface;
an adult gift or novelty contained within said container; and
an outer packaging layer formed around the outer surface of said container.

2. The adult surprise gift apparatus of claim 1, wherein said hollow container is comprised of two or more sections that cooperate with each other to form an ovoid shape when connected.

3. The adult surprise gift apparatus of claim 1, wherein said hollow container is comprised of two sections that are attached to each other by a hinge.

4. The adult surprise gift apparatus of claim 1, wherein said hollow container is made from a biodegradable or compostable plastic.

5. The adult surprise gift apparatus of claim 1, wherein said hollow container is made from a plant based material selected from the group consisting of: cornstarch, mushroom mycelium composite material, protein-polysaccharide polymers, and seaweed.

6. The adult surprise gift apparatus of claim 1, wherein said hollow container is made from pulped card or paper.

7. The adult surprise gift apparatus of claim 1, wherein said hollow container is made from chocolate.

8. The adult surprise gift apparatus of claim 1, wherein said hollow container is additionally dipped in chocolate.

9. The adult surprise gift apparatus of claim 1, wherein said hollow container is encased within a pre-formed hollow chocolate egg.

10. The adult surprise gift apparatus of claim 1, wherein said adult gift or novelty is selected from the group consisting of: massage oils; lube; condoms (including flavored); cock ring; edible underwear; edible bra; body paints; butt plug; thongs; small vibrator (such as bullet; handcuffs; blindfolds; whip; feather ticklers; sex dice; love coupons; nipple clamps; candles—massage oil; oral sex candy; anal beads; enhancing supplements; nipple suckers; sex position cards—collectable; bed restraints; aphrodisiac warming oil; clit stimulator; ball gag; body pasties; panty teaser; collar; leash; Ben wa balls; and oral sex games.

11. The adult surprise gift apparatus of claim 1, wherein said adult gift or novelty is wrapped in a protective covering.

12. The adult surprise gift apparatus of claim 11, wherein said protective covering is selected from the group consisting of cellophane, biodegradable or compostable plastic, and protein-polysaccharide material.

13. The adult surprise gift apparatus of claim 1, wherein said outer packaging layer is selected from the group consisting of cellophane, aluminum, metal foil and ribbon.

14. The adult surprise gift apparatus of claim 1, wherein said outer packaging layer is black and red and contains branding markings.

15. An adult surprise gift apparatus, comprising:
a hollow chocolate shell having an approximate ovoid outer surface;
an adult gift or novelty contained within said hollow chocolate shell; and
an outer packaging layer formed around the outer surface of said hollow chocolate shell.

16. The adult surprise gift apparatus of claim 15, wherein said adult gift or novelty is wrapped in a protective covering.

17. The adult surprise gift apparatus of claim 15, wherein said protective covering is selected from the group consisting of cellophane, biodegradable or compostable plastic, and protein-polysaccharide material.

18. A kit for the preparation of an adult surprise gift apparatus, comprising:
a hollow container having an approximate ovoid outer surface, said container being made from biodegradable or compostable plastic, chocolate or a plant-based material; and
an outer packaging layer formed around the outer surface of said container, said outer packaging layer is selected from the group consisting of cellophane, aluminum, plant-based film, metal foil and ribbon, said packaging further containing branding markings.

19. The kit for the preparation two or more adult surprise gift apparatus of claim 18, comprising;
two or more adult gifts or novelties
two or more hollow containers having an approximate ovoid outer surface, said container being made from biodegradable or compostable plastic, chocolate or a plant-based material; and
two or more outer packaging layers formed around the outer surface of said container, said outer packaging layer is selected from the group consisting of cellophane, aluminum, plant-based film, metal foil and ribbon, said packaging further containing branding markings and optionally instructions for construction of said adult surprise gift apparatus.

20. The kit for the preparation an adult surprise gift apparatus of claim 19, wherein said adult gift or novelty is selected from the group consisting of: massage oils; lube; condoms (including flavored); cock ring; edible underwear; edible bra; body paints; butt plug; thongs; small vibrator (such as bullet; handcuffs; blindfolds; whip; feather ticklers; sex dice; love coupons; nipple clamps; candles—massage oil; oral sex candy; anal beads; enhancing supplements; nipple suckers; sex position cards—collectable; bed restraints; aphrodisiac warming oil; clit stimulator; ball gag; body pasties; panty teaser; collar; leash; Ben wa balls; and oral sex games.
